(19) United States
(12) Patent Application Publication
(10) Pub. No.: US 2009/0219299 A1
(43) Pub. Date: Sep. 3, 2009

(54) Method and system for dynamic color allocation for anti-aliased images in palette-based systems

(75) Inventor: Chris M. McAllen, Nashville, TN (US)

Correspondence Address: NIXON & VANDERHYE, PC, 901 NORTH GLEBE ROAD, 11TH FLOOR, ARLINGTON, VA, 22203, US

(73) Assignee: TOSHIBA AMERICA CONSUMER PRODUCTS, LLC, Wayne, NJ (US)

(21) Appl. No.: 12/318,657

(22) Filed: Jan. 5, 2009

Related U.S. Application Data
(60) Provisional application No. 61/006,283, filed on Jan. 4, 2008.

(51) Int. Cl. G09G 5/02; G09G 5/00

(52) U.S. Cl. 345/600; 345/611

(57) ABSTRACT

Example systems and methods of color allocation for an anti-aliased image involve reserving a number of palette entries in a palette of colors for a graphical user interface and dynamically determining a number of colors for anti-aliasing between first and second colors in the image. The determined anti-aliasing colors are allocated to the reserved palette entries.

### CROSS-REFERENCE TO RELATED APPLICATION

This application claims priority from provisional U.S. application No. 61/006,283, filed Jan. 4, 2008, the contents of which are incorporated herein in their entirety.

### BACKGROUND AND SUMMARY

This application describes methods and systems for dynamic color allocation for anti-aliased images in palette-based systems. The systems and methods described herein may be applied to products with a graphical user interface (GUI) that uses palette-based graphics, and includes anti-aliased text or graphics. Such products include, but are not limited to, televisions, cellular telephones, personal digital assistants (PDAs), portable music (MP3) players, digital cameras, and the like.

In palette-based graphics, a limited number of colors can be displayed on screen at any given time (typically 256). For certain kinds of graphics (most notably text), anti-aliasing is desirable, as it increases the perceived resolution (and therefore the overall quality and legibility) of the graphics. However, this typically requires a large number of color palette entries to be devoted for use by the anti-aliasing colors. This, in turn, reduces the number of colors available for the graphics themselves, which then reduces the overall quality of the images. Finding a good balance is often difficult, and generally results in a) reducing the complexity of the GUI's color scheme, so that only a couple of blended color combinations exist, or b) creating a set of multiple color palettes which are dynamically swapped in/out as needed depending on what is being displayed on screen. The former solution is the simplest, but restricts what can be done artistically, and tends to produce rather bland results. The latter solution allows for richer color schemes, but places a large burden on the design and implementation of the GUI, as all possible color-combination states must be identified and coded for ahead of time (making incremental changes very difficult).

This application describes systems and methods by which software can dynamically alter a color palette at runtime, modifying a small pool of palette entries as needed to provide the anti-aliasing colors required by the GUI at any given time. This maximizes the number of colors available to the GUI, thereby enabling richer color schemes, without any of the drawbacks associated with the aforementioned second solution.

Certain example systems and methods of color allocation for an anti-aliased image involve reserving a number of palette entries in a palette of colors for a graphical user interface and determining a number of colors for anti-aliasing between first and second colors in the image. The determined anti-aliasing colors are allocated to the reserved palette entries.

### BRIEF DESCRIPTION OF THE DRAWINGS

FIG. 1 shows an example system in which dynamic color allocation may be used.

FIG. 2 shows an example palette of 256 colors.

FIG. 3 show components used in an example implementation of dynamic color allocation.

FIGS. 4A-4D show allocating anti-aliasing colors in a palette in accordance with the example dynamic color allocation systems and methods described herein.

### DETAILED DESCRIPTION OF EXAMPLE EMBODIMENTS

Anti-aliasing is a widely-used technique for softening edges (or reducing so-called “jaggies”) between foreground and background objects of different colors. By way of example, the foreground can include text of one color which appears on a background of a different color. Anti-aliasing uses pixels at these edges which have colors that are intermediate (or blends) of the foreground and background colors. These intermediate color pixels create an appearance of smoother edges between the foreground and background colors.

In an implementation described herein by way of example and without limitation, a small pool of palette entries of a color palette is reserved for use by an anti-alias color manager. Whenever GUI software needs to perform anti-aliasing, it makes a request to the anti-alias color manager, and provides the foreground and background colors for the anti-aliasing operation. The anti-alias color manager then determines how many intermediate colors are required to achieve a smooth transition, based on configurable constraints set by the user. The anti-aliasing colors are then calculated, and the reserved palette entries are searched to see if any of the calculated colors already exist in the palette. A number of palette entries equal to the number of colors not already present in the palette are then allocated from the pool of reserved entries, which are in turn assigned the values of the anti-aliasing colors not already present in the palette. The anti-alias color manager then returns the number and palette indices of the computed anti-alias colors, for use by the GUI software.

If all of the reserved palette entries are in use, then the least recently used entries are reclaimed for use by the new anti-alias colors. In practice, this means that the number of reserved palette entries must be at least as large as the worst-case number of anti-aliasing colors that will ever need to be displayed simultaneously on screen at any time. This number can either be determined in advance, or by adding code to profile the usage of the reserved palette entries at runtime, and iterating through all possible GUI display states.

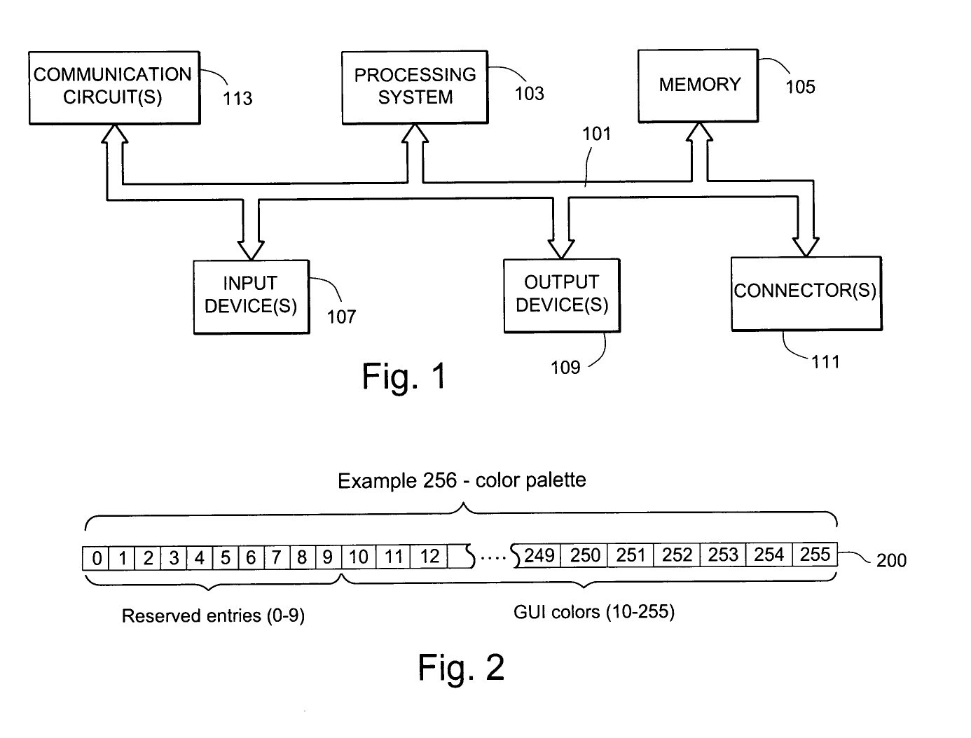

The systems and methods described herein may be used in any system with a graphical user interface (GUI) that uses palette-based graphics, and includes anti-aliased text or graphics. The systems and methods have particular utility in a system in which the palette size is relatively small, such as a system having a palette size of up to 256 colors. Such systems include, but are not limited to, televisions, cellular telephones, personal digital assistants (PDAs), portable music players, digital cameras, and the like. Although it will be readily appreciated that these systems will include different components, each will generally include a processing system, memory, input device(s), output devices (including a display), connector(s) and communication circuits as shown in FIG. 1.

More specifically, FIG. 1 shows various components coupled together via a system bus 101. Processing system 103 may include, for example, a microprocessor, a microcontroller, a processor, a controller, an application specific integrated circuit (ASIC), logic circuitry, a state machine and/or combinations thereof. Memory 105 includes a combination of volatile and non-volatile memory. Memory 105 may include a read only memory (ROM) and a random access memory (RAM). Programs may be loaded from the ROM into the RAM for execution by processing system 103. The RAM may also be used to store other data during execution of programs. Memory 105 may be implemented using one or more of magnetic, optic, magneto-optic and semiconductor memory media and these media may, in some instances, be removable as in the case of memory cards. Inputs (e.g., commands, information, etc.) are provided to the system via input device(s) 107 which may include a keys, buttons, a touchpad, a touch screen, microphones, a trackball, a trackwheel, a joystick, and the like. Outputs are provided via output device(s) 109 which may include a display (e.g., a liquid crystal display, a plasma display, a cathode ray tube, a television, etc.), speakers, vibration mechanisms, and the like. Components (including input devices, output devices, communication devices, peripheral devices) may be connected to the product via various connectors 111 such as USB connectors, serial connectors, parallel connectors, 1394 connectors, Firewire connectors and the like.

The system also includes communication circuits 113 for one or both of short-distance and long-distance wired or wireless communications. These communication circuits may provide for wired or wireless communications using any well-known communication protocol including, but not limited to, public switched telephone network; analog advanced mobile phone service (AMPS), digital advanced mobile phone service (D-AMPS), global system for mobile communications (GSM), personal communication service (PCS), satellite service (including low earth-orbiting satellites), specialized mobile radio (SMR), cellular digital packet data (CDPD), Bluetooth, any version of 802.11 (Wi-Fi), HiperLAN/1, HiperLAN/2, HomeRF, cordless telephone, WiMAX, and the like.

FIG. 2 schematically shows an example palette 200 of 256 colors that may be used by a GUI for a system such as a television, a cellular telephone, a PDA, an MP3 player, a digital camera and the like. Each color is indexed by its position (0-255). In this case, each pixel of an image may be specified using 8-bits (one byte). Other palette sizes may be used and the systems and methods described herein are in not limited to a particular palette size. Nonetheless, the systems and methods described herein are particularly useful in systems having relatively limited color palettes inasmuch as systems having palettes with many thousands of colors are likely to already include colors usable for anti-aliasing between first and second colors. As shown in FIG. 2 and described in greater detail below, palette entries 0-9 of the example palette of 256 colors are reserved and the remaining palette entries 10-255 are GUI colors.

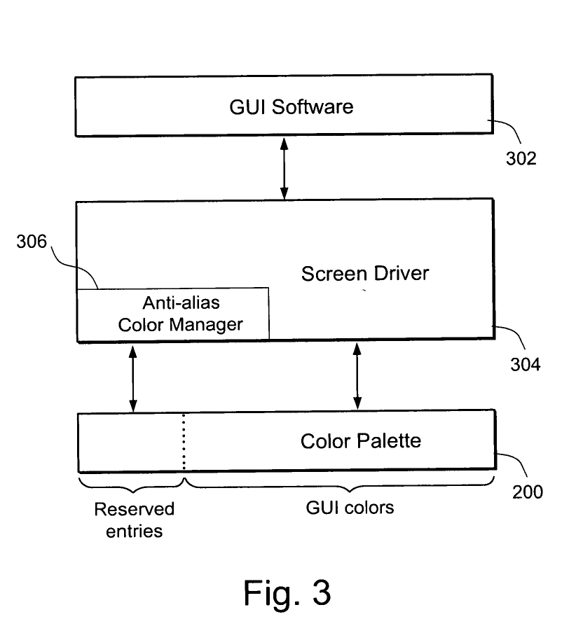

FIG. 3 shows system components used in an illustrative, non-limiting, example of dynamic color allocation. GUI software 302 controls the graphical user interface for the system. An example of GUI software with which the color allocation systems and methods described herein may be used is GUI software for a menu system displayed on a display screen such as a television. Among other things, GUI software 302 determines a foreground and background color used for the GUI. In the case of a menu system, the text of a first color may be displayed on a background of a different, second color and these text/background color combinations may change as a user moves from one menu to another in the menu system. Screen driver 304 includes an anti-alias color manager 306 that computes the number of required anti-alias colors for given foreground and background colors. This ensures that the required colors are present in the reserved section of the palette. If there is an insufficient number of available entries in the reserved section of the palette, the anti-alias color manager removes least-recently used colors until sufficient room is available. The anti-alias color manager then returns to the GUI software a list of palette indices which includes the anti-alias colors for given foreground and background colors.

The anti-alias colors may be combinations of the foreground and background colors. By way of example, if the foreground is black and the background is white, the anti-alias colors may be various shades of gray. By way of further example, if the foreground is red and the background is white, the anti-alias colors may be various shades of pink. The amounts of foreground/background colors in an anti-alias color may be based on the relative amounts of these colors for a particular pixel. For example, in the case of a black foreground on a white background, a half-covered pixel may be a gray composed of 50% white and 50% black. The palette described herein can provide multiple anti-alias colors for anti-aliasing between foreground and background colors. As one example, a first anti-alias color may be a combination of 25% of the first color and 75% of the second color; a second anti-alias color may be a combination of 50% of the first color and 50% of the second color; and a third anti-alias color may be a combination of 75% of the first color and 25% of the second color. Which of these anti-alias colors is used may be determined based on which combination is closest to the actual relative amounts of foreground and background colors for a particular pixel.

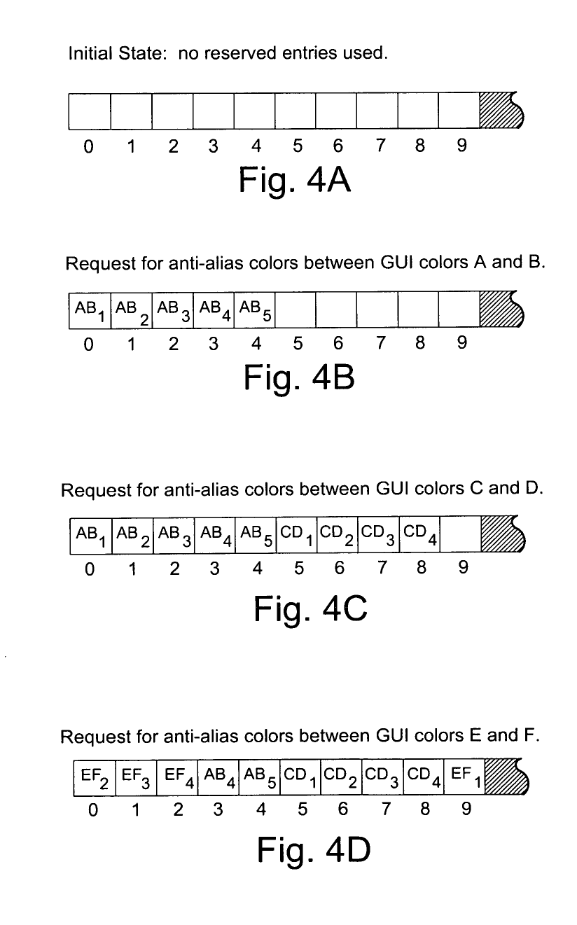

An example of the dynamic color allocation process is explained in greater detail with reference to FIGS. 4A-4D.

FIG. 4A shows an initial state of a 256-color color palette in which no entries are reserved. In response to a request from GUI software 302 for anti-alias colors between GUI colors A and B (e.g., for text of a first color on a background of a second color), anti-alias color manager 306 determines, in this example, that five (5) intermediate colors are needed for sufficiently smoothing edges. If these colors are not present in the color palette, as is the case in this example, five (5) unused reserved entries 0-4 are allocated for colors AB₁, AB₂, AB₃, AB₄ and AB₅ as shown in FIG. 4B.

In response to a request from GUI software 302 for anti-alias colors between GUI colors C and D (e.g., for text of a third color on a background of a fourth color), anti-alias color manager 306 determines, in this example, that four (4) intermediate colors are needed. If these colors are not present in the color palette, as is the case in this example, four (4) unused entries reserved entries 5-8 are allocated for colors CD₁, CD₂, CD₃, CD₄ as shown in FIG. 4C.

In response to another request from GUI software 302 for anti-alias colors between GUI colors A and B (e.g., for text of the first color on a background of the second color), no action is required because these colors are still present in the palette.

In response to a request from GUI software 302 for anti-alias colors between GUI colors E and F (e.g., for text of a fifth color on a background of a sixth color), anti-alias color manager 306 determines, in this example, that four (4) intermediate colors are needed. If these colors are not present in the color palette, as is the case in this example, the one (1) remaining unused reserved palette entry 9 is allocated and the three least-recently used entries (i.e., 0-2) are re-used for colors EF₁, EF₂, EF₃ and EF₄ as shown in FIG. 4D.

As described above, the example software can dynamically alter a color palette at runtime, modifying a small pool of palette entries as needed to provide anti-aliasing colors required by the GUI at any given time. This maximizes the number of colors available to the GUI, thereby enabling richer color schemes, without the drawbacks of placing a large burden on the design and implementation of the GUI, to identify and code all possible color-combination states ahead of time, thereby making incremental changes very difficult.

The various aspects of the systems and methods described herein may be implemented as part of a software program executed by a processing system such as the processing system 103 discussed above. This program can, for example, be stored in a computer-readable medium such as memory 105. As mentioned above, memory 105 may implemented as magnetic memory, optical memory, semiconductor memory, magneto-optic memory, combinations thereof and the like. In another example, the program may be available for downloading over the internet so that the program may be delivered via a communication network. Updates may be provided via downloads. Further, a carrier wave may be modulated by a signal representing the corresponding program and an obtained modulated wave may be transmitted, so that the system which receives the modulated wave may demodulate the modulated wave to restore the corresponding program.

While the systems and methods have been described in connection with what is presently considered to practical and preferred embodiments, it is to be understood that these systems and methods are not limited to the disclosed embodiments, but on the contrary, is intended to cover various modifications and equivalent arrangements included within the spirit and scope of the appended claims.

I claim:

1. A method of color allocation for an anti-aliased image, the method comprising:
reserving a number of palette entries in a palette of colors for a graphical user interface;
dynamically determining a number of colors for anti-aliasing between first and second colors in the image; and
allocating the determined anti-aliasing colors to the reserved palette entries.

2. The method according to claim 1, wherein the palette has up to 256 colors.

3. The method according to claim 1, wherein the palette has up to no more than 256 colors.

4. The method according to claim 1, wherein the first and second colors are background and foreground colors.

5. The method according to claim 1, further comprising:
determining if a number of unused reserved palette entries is greater than or equal to the number of anti-aliasing colors; and
removing anti-aliasing colors currently contained in the reserved palette entries to accommodate the determined anti-aliasing colors.

6. The method according to claim 5, wherein the removing of anti-aliasing colors is based on a time of use of the colors currently contained in the reserved palette.

7. The method according to claim 6, wherein the least-recently used color currently contained in the reserved palette a removed to accommodate the determined anti-aliasing colors.

8. A method comprising:
reserving a number of palette entries in a palette of colors for a graphical user interface; and
dynamically varying the colors contained in the reserved palette entries in the palette based on anti-alias colors for anti-aliasing an image comprising different foreground and background colors.

9. A color allocation system for an anti-aliased image, comprising:
a palette of colors comprising reserved palette entries; and
a color manager for dynamically determining a number of colors for anti-aliasing between first and second colors of the image and allocating the determined anti-aliasing colors to the reserved palette entries.

10. The system according to claim 9, wherein the palette has up to 256 colors.

11. The system according to claim 9, wherein the palette has up to no more than 256 colors.

12. The system according to claim 9, wherein the first and second colors are background and foreground colors.

13. The system according to claim 9, wherein the color manager further:
determines if a number of unused reserved palette entries is greater than or equal to the number of anti-aliasing colors; and
removes anti-aliasing colors currently contained in the reserved palette entries to accommodate the determined anti-aliasing colors.

14. The system according to claim 13, wherein the removing of anti-aliasing colors is based on a time of use of the colors currently contained in the reserved palette.

15. The system according to claim 14, wherein the least-recently used color currently contained in the reserved palette a removed to accommodate the determined anti-aliasing colors.

16. An apparatus comprising a color allocation system according to claim 9.

17. The apparatus according to claim 16, wherein the apparatus comprises a television.

18. The apparatus according to claim 16, wherein the apparatus comprises a personal digital assistant.

19. The apparatus according to claim 16, wherein the apparatus comprises a cellular telephone.

20. The apparatus according to claim 16, wherein the apparatus comprises a portable music player.

21. The apparatus according to claim 16, wherein the apparatus comprises a digital camera.

22. A computer readable medium having stored therein program instructions for a method for color allocation for an anti-aliased image, the method comprising:
reserving a number of palette entries in a palette of colors for a graphical user interface;
dynamically determining a number of colors for anti-aliasing between first and second colors in the image; and
allocating the determined anti-aliasing colors to the reserved palette entries.
